(19) United States
(12) Patent Application Publication
(10) Pub. No.: US 2012/0242183 A1
(43) Pub. Date: Sep. 27, 2012

(54) ARMATURE WINDING OF ROTATING ELECTRICAL MACHINE

(76) Inventors: Tadashi TOKUMASU, Tokyo (JP); Takashi Ueda, Yokohama-shi (JP); Masayuki Ichimonji, Tokyo (JP); Toru Otaka, Kawasaki-shi (JP); Daisuke Hiramatsu, Tokyo (JP); Mikio Kakiuchi, Yokohama-shi (JP)

(21) Appl. No.: 13/425,199

(22) Filed: Mar. 20, 2012

(30) Foreign Application Priority Data
Mar. 24, 2011 (JP) 2011-066661

(51) Int. Cl. H02K 3/28

(52) U.S. Cl. 310/195

(57) ABSTRACT

According to one embodiment, there is provided a 3-phase 4-pole 2-layer armature winding of a rotating electrical machine. A winding of each phase of the armature winding forms a series coil. Each series coil includes upper coil pieces and lower coil pieces which are connected each other at a connection side coil end and a counter-connection side coil end, the upper coil pieces and lower coil pieces being placed in 54 slots provided in an armature core. At least one coil piece of the upper and lower coil pieces, provided in at least one of an innermost position and an outermost position from the center of a phase belt of each phase, is replaced with a coil piece of an adjacent phase.

### CROSS-REFERENCE TO RELATED APPLICATIONS

This application is based upon and claims the benefit of priority from prior Japanese Patent Application No. 2011-066661, filed Mar. 24, 2011, the entire contents of which are incorporated herein by reference.

### FIELD

Embodiments described herein relate generally to an armature winding of a rotating electrical machine.

### BACKGROUND

In a large capacity rotating electrical machine, an armature winding includes upper and lower coil pieces formed in two layers in slots provided in an armature core configured by a laminated core, and the coil pieces are connected in series to increase a generated voltage and machine capacity. However, as a voltage of an armature winding increases, main insulation thickness becomes thick, a cross-sectional area of a conductor decreases, and a current density increases, causing an increased loss. If a voltage of an armature winding is extremely increased, the reliability of main insulation is decreased.

The number of slots is important for setting a voltage of an armature winding. In a 4-pole 3-phase machine, the number of slots is reduced to half of a 2-pole machine by using so-called integer slots, in which the number of slots can be divided by the number of poles and phases, and design flexibility is limited. To avoid such a defect, it is necessary to design a machine with fractional slots, for example, a 4-pole 54-slot machine, in which the number of slots cannot be divided by the number of poles and phases.

A magnetic flux per pole to generate the same voltage is half of a 4-pole machine compared with a 2-pole machine, and the thickness of an armature core yoke can be reduced by just that much.

In a rotating electrical machine, a magnetic flux generated in a gap between an armature and a rotor generates an electromagnetic force to attract an armature core to a rotor, and the electromagnetic force generates circular vibration when a rotor rotates. As the electromagnetic force has power proportional to a square of a magnetic flux density B, an electromagnetic force at a lowest frequency is generated by a magnetic flux element corresponding to an electrical frequency, and becomes an excitation force having a frequency double the electrical frequency. Generally, a space harmonic component of a magnetic flux in a gap is considered to be a space harmonic component of a magnetic flux Bf generated by a field current, and a space harmonic component of a magnetic flux Ba generated by an armature current. In the above space harmonic components, only a harmonic component of the magnetic flux Ba generated by an armature current corresponds to an electrical frequency. Therefore, a magnetic flux component corresponding to an electrical frequency is expressed as follows, assuming θ to be a machine angle, because a space harmonic component of a multiple of 3 is usually canceled in a 3-phase 4-pole machine.

$$B = {B}_{1} cos ( 2 θ - ω t ) + {B}_{a 2} cos ( 4 θ + ω t ) + {B}_{a 4} cos ( 8 θ - ω t ) + {B}_{a 5} cos ( 10 θ + ω t ) + {B}_{a 7} cos ( 14 θ - ω t ) + …$$

Generally, a winding coefficient for an even-ordered space harmonic is zero in an integer-slot machine as shown in Table 1, and an even-ordered space harmonic component of a magnetic flux is also zero. Therefore, an electromagnetic excitation force Fa acting on an armature core is proportional to an AC component of a square of a magnetic flux density corresponding to an electrical frequency shown below.

$${B}_{ac}^{2} = \frac{1}{2} {B}_{1}^{2} cos ( 4 θ - 2 ω t ) + {B}_{1} {B}_{a 5} cos ( 8 θ + 2 ω t ) + {B}_{1} {B}_{a 7} cos ( 16 θ - ω t ) + …$$

Therefore, an electromagnetic excitation force Fa acting on an armature core is expressed as follows.

Fₐ=Fₐ₄ cos(4θ−2ωt)+Fₐ₈ cos(8θ+ωt)+Fₐ₁₆ cos(16θ−2ωt)+ . . .

Here, an electromagnetic excitation force of a lowest space harmonic order is an 8-pole component (4-diameter node mode), and a 4-diameter node mode is apt to be excited for vibration of a core.

On the other hand, in a fractional-slot machine, for example a 4-pole 54-slot machine, the number of slots 54 cannot be divided by the number of poles, and a winding of each phase is wound such that a phase belt 17 including four coils and a phase belt 18 including five coils are alternately arranged in a circumferential direction, as shown in FIG. 7. Therefore, in a single-phase armature winding 14, a phase belt 17 including four coils and a phase belt 18 including five coils alternately appear corresponding to each magnetic pole position, as shown in FIG. 8. Thus, symmetry is not established for each magnetic pole, and a winding coefficient for an even-ordered space harmonic is not zero, as shown in Table 1. Consequently, an electromagnetic excitation force Fa acting on an armature core is proportional to an AC component of a square of a magnetic flux density corresponding to an electrical frequency shown below.

$${B}_{ac}^{2} = \frac{1}{2} {B}_{1}^{2} cos ( 4 θ - 2 ω t ) + {B}_{1} {B}_{a 5} cos ( 8 θ + 2 ω t ) + {B}_{1} {B}_{a 7} cos ( 16 θ - ω t ) + …$$

Therefore, an electromagnetic excitation force Fa acting on an armature core is expressed as follows.

Fₐ=Fₐ₂ cos(2θ+2ωt)+Fₐ₄ cos(4θ−2ωt)+Fₐ₈ cos(8θ+ωt)+Fₐ₁₀ cos(10θ−2ωt)+ . . .

Here, a 4-pole component (2-diameter node mode) appears as a lowest order electromagnetic excitation force.

As a cause of an electromagnetic excitation force of a 4-pole component (2-diameter node mode), for example, the interaction between a fourth-order harmonic component Ba4 and a fifth-order harmonic component Ba5 is considerable in addition to the above-mentioned interaction between a basic wave magnetic flux density B1 and a second-order harmonic component Ba2. However, as the ratio of a basic wave B1 to a magnetic flux density is generally high, a value of second-order harmonic component Ba2 is considered to determine a value of electromagnetic excitation force of a 4-pole component (2-diameter node mode).

TABLE 1
Example of winding coefficient
of 4-pole machine

| | Slot | Slot | Space harmonic order | | | | |
|---|---|---|---|---|---|---|---|
| Kind | No. | pitch | 1 | 2 | 4 | 5 | 7 |
| Integer | 48 | 10 | 0.9250 | 0.0000 | 0.0000 | 0.0531 | 0.0408 |
| slot | | | | | | | |
| Fractional | 54 | 11 | 0.9153 | 0.0307 | 0.0524 | 0.0225 | 0.0630 |
| slot | | | | | | | |

In circular vibration, as a mode number of diameter node mode decreases, a natural vibration frequency decreases. Therefore, it is general to detune a natural vibration frequency for a lowest order excitation frequency in an armature core. However, as described above, an armature core yoke is made thin in a 4-pole machine, and the rigidity of an armature core for circular vibration is lower than a 2-pole machine, and it is sometimes difficult to sufficiently detune a natural vibration frequency for circular vibration in 2-diameter node mode. In such a case, excessive core vibration may be induced by an electromagnetic excitation force of a 4-pole component (2-diameter node mode) generated in a fractional-slot machine.

Under the circumstances, it is desired to provide an armature winding of a rotating electrical machine, in which an electromagnetic excitation force of a 4-pole component induced by a magnetic flux generated by an armature current is decreased, vibration of an armature core is decreased, and the reliability is increased.

### BRIEF DESCRIPTION OF THE DRAWINGS

FIG. 1 is a developed schematic diagram showing one phase of an armature winding of a rotating electrical machine according to a first embodiment;

FIG. 2 is a developed schematic diagram showing a cross section of an armature of a rotating electrical machine according to the same embodiment;

FIG. 3 is a developed schematic diagram showing one phase of an armature winding of a rotating electrical machine according to a second embodiment;

FIG. 4 is a developed schematic diagram showing one phase of an armature winding of a rotating electrical machine according to a third embodiment;

FIG. 5 is a developed schematic diagram showing one phase of an armature winding of a rotating electrical machine according to a fourth embodiment;

FIG. 6 is a developed schematic diagram showing one phase of an armature winding of a rotating electrical machine according to a fifth embodiment;

FIG. 7 is a developed schematic diagram showing a cross section of an armature of a conventional rotating electrical machine; and

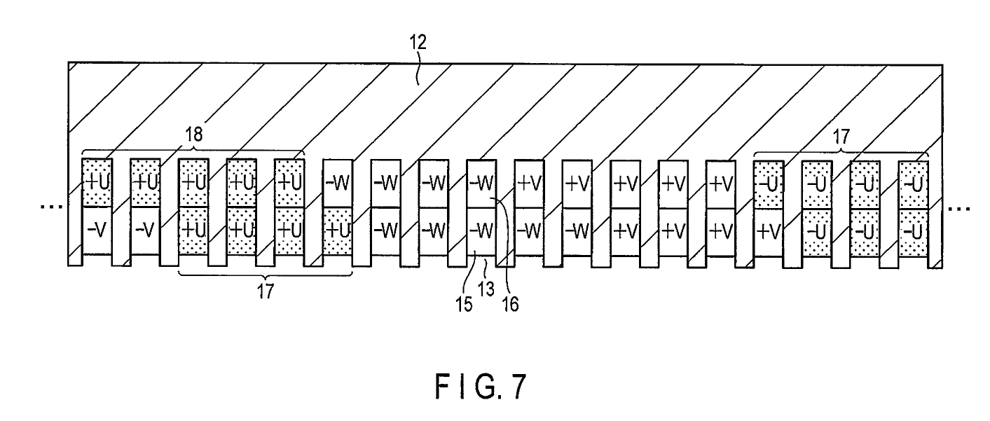

FIG. 8 is a developed schematic diagram showing one phase of an armature winding of a conventional rotating electrical machine.

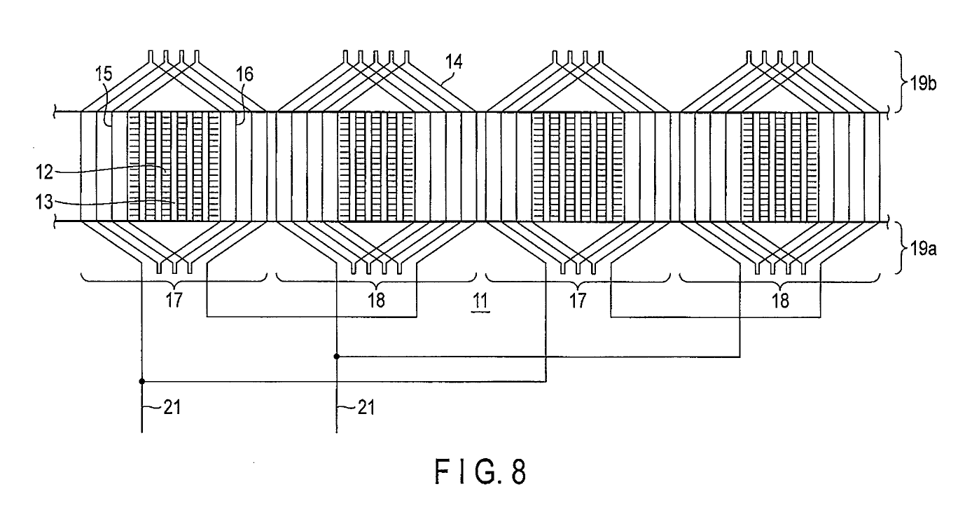

### DETAILED DESCRIPTION

Embodiments will be described below with reference to the drawings. In general, according to one embodiment, there is provided a 3-phase 4-pole 2-layer armature winding of a rotating electrical machine. A winding of each phase of the armature winding forms a series coil. Each series coil includes upper coil pieces and lower coil pieces which are connected each other at a connection side coil end and a counter-connection side coil end, the upper coil pieces and lower coil pieces being placed in 54 slots provided in an armature core. At least one coil piece of the upper and lower coil pieces, provided in at least one of an innermost position and an outermost position from the center of a phase belt of each phase, is replaced with a coil piece of an adjacent phase.

### First Embodiment

First, an armature winding of a rotating electrical machine according to a first embodiment will be explained.

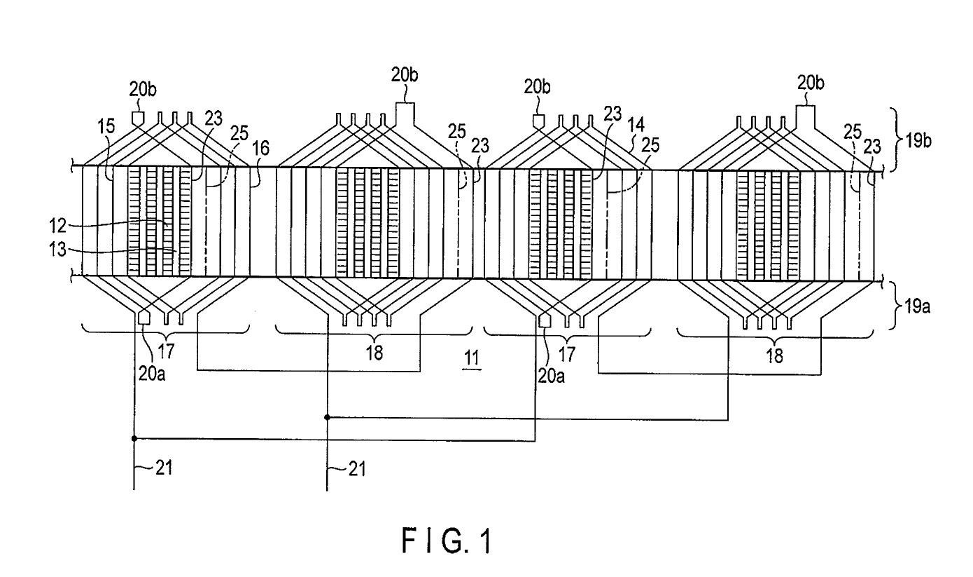

FIG. 1 is a developed schematic diagram showing one phase of an armature winding of a rotating electrical machine according to a first embodiment.

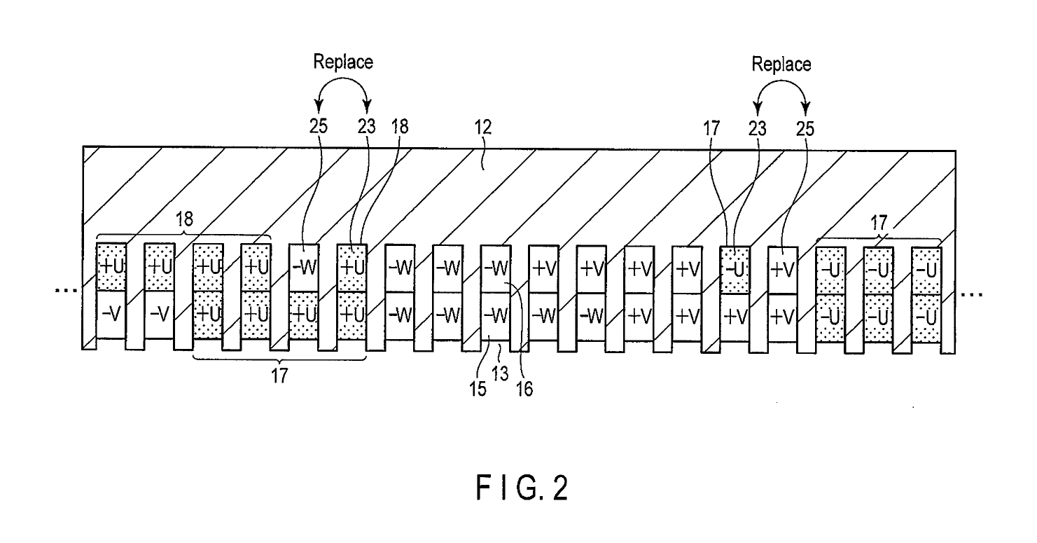

FIG. 2 is a developed schematic diagram showing a cross section of an armature of a rotating electrical machine according to the same embodiment.

An armature 11 of a rotating electrical machine is provided with 54 slots 13 in an armature core 12 configured by a laminated core, and an armature winding 14 of a 4-pole 3-phase circuit is formed in two layers in slots 13.

An armature winding 14 of each phase includes upper coil pieces 15 placed in an upper part of slots 13, and lower coil pieces 16 placed in a lower part of slots 13. The ends of the upper and lower coil pieces 15 and 16 are connected in series at a connection side coil end 19a connected to a lead wire of a winding, and a counter-connection side coil end 19b opposite along a shaft and unconnected to a lead wire of a winding. Further, an armature winding 14 includes a phase belt 17 including four coils, in which upper and lower coil pieces 15 and 16 are placed in four slots 13 provided in the armature core 12, and a phase belt 18 including five coils, in which upper and lower coil pieces 15 and 16 are placed in five slots 13 provided in the armature core 12.

Upper coil pieces 15 of each of the phase belts 17 and 18 are connected to corresponding lower coil pieces 16 separated by a predetermined coil pitch, at the connection side and counter-connection side coil ends 19a and 19b, thereby forming a series coil. A phase belt 17 including four series coils and a phase belt 18 including five series coils are connected in series. Two sets of circuit including series-connected 4-coil and 5-coil phase belts 17 and 18 is connected in parallel through a lead-out conductor 21 provided at the connection side coil end 19a, thereby forming an armature winding 14. FIG. 1 shows an example using a small coil pitch 8 for convenience of viewing. A coil pitch is not to be limited to this value. This is the same in other diagrams.

In FIG. 1, two jumper wires 20a are provided per phase at a connection side coil end 19a of each of the phase belts 17 and 18, and four jumper wires 20b are provided per phase at a counter-connection side coil end 19b, and a coil position is indicated by a position from the center of phase in each phase belt. In a 4-coil phase belt 17, a lower coil piece 23 in an innermost position from the center of the phase belt is replaced with a lower coil piece 25 of a 5-coil phase belt of an adjacent different phase. In a 5-coil phase belt 18, a lower coil piece 23 in an outermost position from the center of the phase belt is replaced with a lower coil piece 25 of a 4-coil phase belt of an adjacent different phase.

Generally, in an armature winding, a coil pitch is determined to reduce fifth-order and seventh-order space winding coefficients to prevent deterioration of an induced voltage waveform and rotor surface loss. In a conventional example of a 4-pole 54-slot armature winding, only a winding with a coil pitch 11 shown in Table 1 can be selected to reduce fifth-order and seventh-order space winding coefficients to less than 10%.

Table 2 shows the relationship between a coil pitch and a winding coefficient of each order space in the first embodiment. Comparing Table 2 with Table 1, fifth-order and seventh-order space winding coefficients are reduced to less than 10% when a coil pitch is 10 to 12 in the first embodiment, and a second-order space winding coefficient is lower than a value in a conventional example shown in Table 1 in any case. Therefore, a second-order space harmonic component of a magnetic flux formed by an armature current can be reduced.

Table 2 omits other coil pitches than 9 to 14. Coil pitches other than 9 to 14 are usually not used, because a coil size becomes too large or small, or a sufficient effect is not obtained.

TABLE 2
Relationship between coil pitch and winding coefficient
in first embodiment

| | Coil pitch | | | | | |
|---|---|---|---|---|---|---|
| | 9 | 10 | 11 | 12 | 13 | 14 |
| Basic wave | 0.8160 | 0.8652 | 0.9028 | 0.9281 | 0.9410 | 0.9410 |
| winding | | | | | | |
| coefficient | | | | | | |
| Second-order | 0.0390 | 0.0267 | 0.0139 | 0.0083 | 0.0191 | 0.0320 |
| space winding | | | | | | |
| coefficient | | | | | | |
| Fifth-order | 0.1335 | 0.0972 | 0.0561 | 0.0808 | 0.1245 | 0.1387 |
| space winding | | | | | | |
| coefficient | | | | | | |
| Seventh-order | 0.0423 | 0.0892 | 0.0995 | 0.0593 | 0.0480 | 0.0940 |
| space winding | | | | | | |
| coefficient | | | | | | |

As described above, in the first embodiment, in a 4-coil phase belt 17, a lower coil piece 23 in an innermost position from the center of the phase belt is replaced with a lower coil piece 25 of a 5-coil phase belt of an adjacent different phase. In a 5-coil phase belt 18, and a lower coil piece 23 in an outermost position from the center of the phase belt is replaced with a lower coil piece 25 of a 4-coil phase belt of an adjacent different phase. A winding coefficient for a second-order space harmonic can be minimized by setting a coil pitch to 12. A second-order space harmonic component of a magnetic flux generated by an armature current is reduced. A magnetic flux of a second-order space harmonic component acts on a main magnetic flux, and generates a 2-diameter node magnetic excitation force. By reducing a magnetic flux of a second-order space harmonic component, an electromagnetic excitation force of a 2-diameter node is generated, vibration of a 2-diameter node stator core is reduced, and a reliable armature can be provided.

The embodiment is not limited to the configuration shown in the diagrams. The same function and effect can be obtained even when upper coil pieces 15 are replaced with lower coil pieces 16 in FIG. 1, and vice versa, a lower coil piece 23 replaced with a different phase is assumed to be an upper coil piece 22 replaced with a different phase, and a lower coil piece 25 of a different phase is replaced with an upper coil piece of a different phase. The function and effect are the same even when a lead-out position is changed from the diagrams. Further, in FIG. 1, two parallel windings are formed by connecting two sets of circuit including 4-coil and 5-coil phase belts 17 and 18 in parallel. The same function and effect can be obtained even when an armature winding is formed by connecting two sets of circuit in series.

### Second Embodiment

Next, an armature winding of a rotating electrical machine according to a second embodiment will be explained.

In the second embodiment, elements common to the first embodiment are given the same reference numbers, and a redundant explanation is omitted. Parts different from the first embodiment are mainly explained.

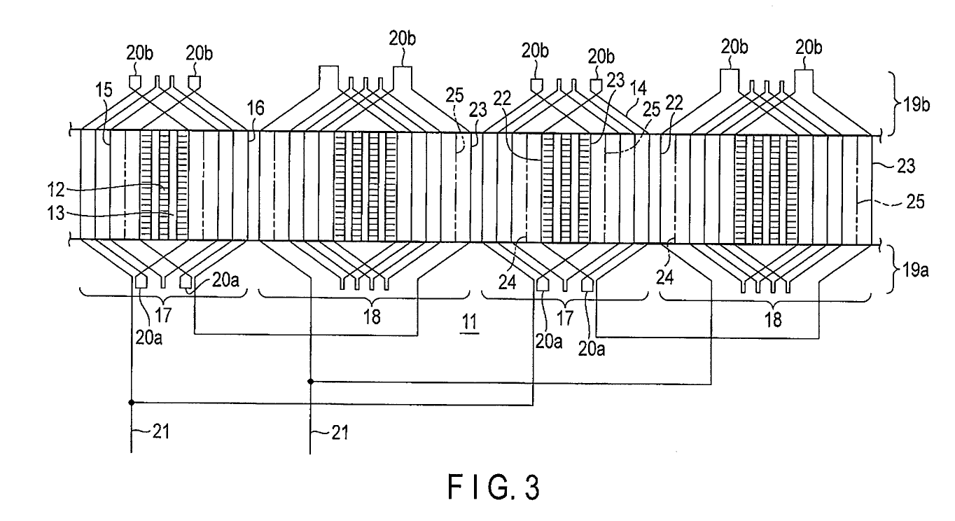

FIG. 3 is a developed schematic diagram showing one phase of an armature winding of a rotating electrical machine according to a second embodiment.

In FIG. 3, four jumper wires 20a are provided per phase at a connection side coil end 19a of each of the phase belts 17 and 18, and eight jumper wires 20b are provided per phase at a counter-connection side coil end 19b. In a 4-coil phase belt 17, an upper coil piece 22 in an innermost position from the center of the phase belt is replaced with an upper coil piece 24 of a 5-coil phase belt of an adjacent different phase, and a lower coil piece 23 in an innermost position from the center of the phase belt is replaced with a lower coil piece 25 of a 5-coil phase belt of an adjacent different phase. In a 5-coil phase belt 18, a upper coil piece 22 in an outermost position from the center of the phase belt is replaced with an upper coil piece 24 of a 4-coil phase belt of an adjacent different phase, and a lower coil piece 23 in an outermost position from the center of the phase belt is replaced with a lower coil piece 25 of a 4-coil phase belt of an adjacent different phase.

Table 3 shows the relationship between a coil pitch and a winding coefficient of each order space in the second embodiment. Comparing Table 3 with Table 1, fifth-order and seventh-order space winding coefficients are reduced to less than 10% when a coil pitch is 9 to 11 in a second embodiment, and a second-order space winding coefficient is lower than a value in a conventional example shown in Table 1. Therefore, a second-order space harmonic component of a magnetic flux formed by an armature current can be reduced.

TABLE 3
Relationship between coil pitch and winding coefficient
in second embodiment

| | Coil pitch | | | | | |
|---|---|---|---|---|---|---|
| | 9 | 10 | 11 | 12 | 13 | 14 |
| Basic wave | 0.8044 | 0.8531 | 0.8902 | 0.9153 | 0.9281 | 0.9282 |
| winding | | | | | | |
| coefficient | | | | | | |
| Second-order | 0.0178 | 0.0014 | 0.0151 | 0.0307 | 0.0448 | 0.0564 |
| space winding | | | | | | |
| coefficient | | | | | | |
| Fifth-order | 0.0840 | 0.0657 | 0.0259 | 0.0225 | 0.0635 | 0.0835 |
| space winding | | | | | | |
| coefficient | | | | | | |
| Seventh-order | 0.0391 | 0.0105 | 0.0536 | 0.0630 | 0.0328 | 0.0179 |
| space winding | | | | | | |
| coefficient | | | | | | |

As described above, in the second embodiment, in a 4-coil phase belt 17, innermost upper and lower coil pieces 22 and 23 in innermost positions from the center of the phase belt are replaced with an upper coil piece 24 and lower coil piece 25 of a 5-coil phase belt of an adjacent different phase, respectively. In a 5-coil phase belt 18, outermost upper and lower coil pieces 22 and 23 in outermost positions from the center of a phase are replaced with an upper coil piece 24 and lower coil piece 25 of a 4-coil phase belt of an adjacent different phase, respectively. A winding coefficient for a second-order space harmonic can be minimized by setting a coil pitch to 10. A second-order space harmonic component of a magnetic flux generated by an armature current is reduced. A magnetic flux of a second-order space harmonic component acts on a main magnetic flux, and generates a 2-diameter node magnetic excitation force. By reducing a magnetic flux of a second-order space harmonic component, an electromagnetic excitation force of a 2-diameter node is generated, vibration of a 2-diameter node stator core is reduced, and a reliable armature can be provided.

In the second embodiment, compared with the first embodiment, the numbers of jumper wires 20a and 20b at the connection side and counter-connection side coil ends are increased, but a second-order space harmonic component is effectively reduced, and the effect is high over a wide range of coil pitches.

The embodiment is not limited to the configuration shown in the diagrams.

The same function and effect are obtained even when a lead-out position is changed from the diagrams. Further, in FIG. 3, two parallel windings are formed by connecting two sets of circuit including 4-coil and 5-coil phase belts 17 and 18 in parallel. The same function and effect can be obtained even when an armature winding is formed by serially connecting two sets of circuit.

### Third Embodiment

Next, an armature winding of a rotating electrical machine according to a third embodiment will be explained.

In the third embodiment, elements common to the first embodiment are given the same reference numbers, and an explanation thereof is omitted. Parts different from the first embodiment are mainly explained.

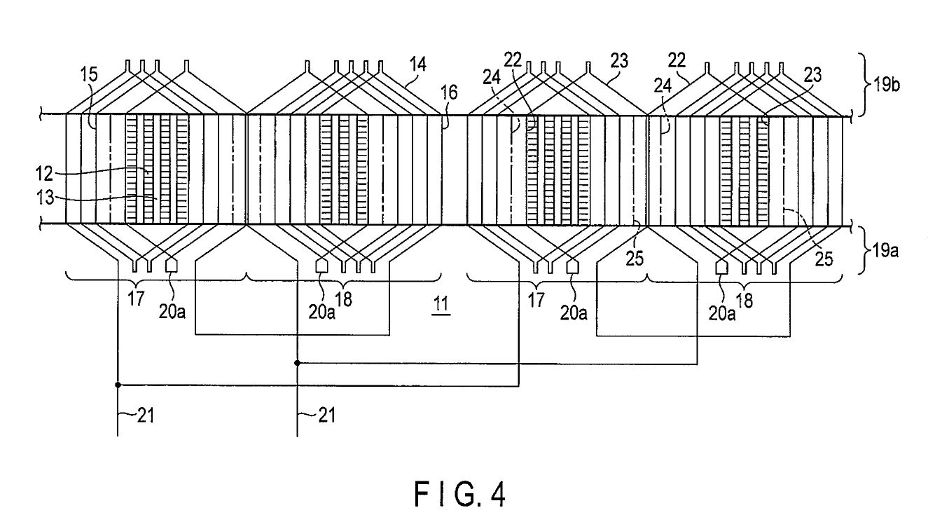

FIG. 4 is a developed schematic diagram showing one phase of an armature winding of a rotating electrical machine according to a third embodiment.

In FIG. 4, four jumper wires 20a are provided per phase at a connection side coil end 19a of each of the phase belts 17 and 18. In a 4-coil phase belt 17, an upper coil piece 22 in an innermost position from the center of a phase is replaced with an upper coil piece 24 of a 5-coil phase belt of an adjacent different phase, and a lower coil piece 23 in an outermost position from the center of the phase belt is replaced with a lower coil piece 25 of a 5-coil phase belt of an adjacent different phase. In a 5-coil phase belt 18, an upper coil piece 22 in an outermost position from the center of the phase belt is replaced with an upper coil piece 24 of a 4-coil phase belt of an adjacent different phase, and a lower coil piece 23 in an innermost position from the center of the phase belt is replaced with a lower coil piece 25 of a 4-coil phase belt of an adjacent different phase.

Table 4 shows the relationship between a coil pitch and a winding coefficient of each order space in the third embodiment. Comparing Table 4 with Table 1, fifth-order and seventh-order space winding coefficients are reduced to less than 10% when a coil pitch is 12 to 14 in the third embodiment, and a second-order space winding coefficient is lower than a value shown in a conventional example in Table 1. Therefore, a second-order space harmonic component in a magnetic flux formed by an armature current can be reduced.

TABLE 4
Relationship between coil pitch and winding coefficient
in third embodiment

| | Coil pitch | | | | | |
|---|---|---|---|---|---|---|
| | 9 | 10 | 11 | 12 | 13 | 14 |
| Basic wave | 0.8052 | 0.8537 | 0.8907 | 0.9156 | 0.9281 | 0.9281 |
| winding | | | | | | |
| coefficient | | | | | | |
| Second-order | 0.0618 | 0.0519 | 0.0392 | 0.0244 | 0.0083 | 0.0083 |
| space winding | | | | | | |
| coefficient | | | | | | |
| Fifth-order | 0.0730 | 0.0379 | 0.0098 | 0.0542 | 0.0808 | 0.0808 |
| space winding | | | | | | |
| coefficient | | | | | | |
| Seventh-order | 0.0559 | 0.0618 | 0.0290 | 0.0221 | 0.0593 | 0.0593 |
| space winding | | | | | | |
| coefficient | | | | | | |

As described above, in the third embodiment, in a 4-coil phase belt 17, an upper coil piece 22 in an innermost position and a lower coil piece 23 in an outermost position from the center of the phase belt are replaced with an upper coil piece 24 and a lower coil piece 25 of a 5-coil phase belt of an adjacent different phase, respectively. In a 5-coil phase belt 18, an upper coil piece 22 in an outermost position and a lower coil piece 23 in an innermost position from the center of the phase belt are replaced with an upper coil piece 24 and a lower coil piece 25 of a 4-coil phase belt of an adjacent different phase, respectively. A winding coefficient for a second-order space harmonic can be minimized by setting a coil pitch to 13. A second-order space harmonic component of a magnetic flux generated by an armature current is reduced. A magnetic flux of a second-order space harmonic component acts on a main magnetic flux, and generates a 2-diameter node magnetic excitation force. By reducing a magnetic flux of a second-order space harmonic component, an electromagnetic excitation force of a 2-diameter node is generated, vibration of a 2-diameter node stator core is reduced, and a reliable armature can be provided.

In the third embodiment, compared with the first and second embodiments, a jumper wire 20b at the counter-connection side coil end is unnecessary.

The embodiment is not limited to the configuration shown in the diagrams. The same function and effect can be obtained even when upper coil pieces 15 in FIG. 4 are replaced with lower coil pieces 16, an upper coil piece 22 replaced with a different phase is assumed to be a lower coil piece 23 replaced with a different phase, an upper coil piece 24 of a different phase is assumed to be a lower coil piece 25 of a different phase, lower coil pieces 16 are assumed to be upper coil pieces 15, a lower coil piece 23 replaced with a different phase is assumed to be an upper coil piece 22 replaced with a different phase, and a lower coil piece 25 of a different phase is assumed to be an upper coil piece 24 of a different phase. The function and effect are the same even when a lead-out position is changed from that shown in the diagrams. Further, in FIG. 4, two parallel windings are formed by connecting two sets of circuit including 4-coil and 5-coil phase belts 17 and 18 in parallel. The same function and effect can be obtained even when an armature winding is formed by connecting two sets of circuit in series.

### Fourth Embodiment

Next, an armature winding of a rotating electrical machine according to a fourth embodiment will be explained.

In the fourth embodiment, elements common to the first embodiment are given the same reference numbers, and an explanation thereof is omitted. Parts different from the first embodiment are mainly explained.

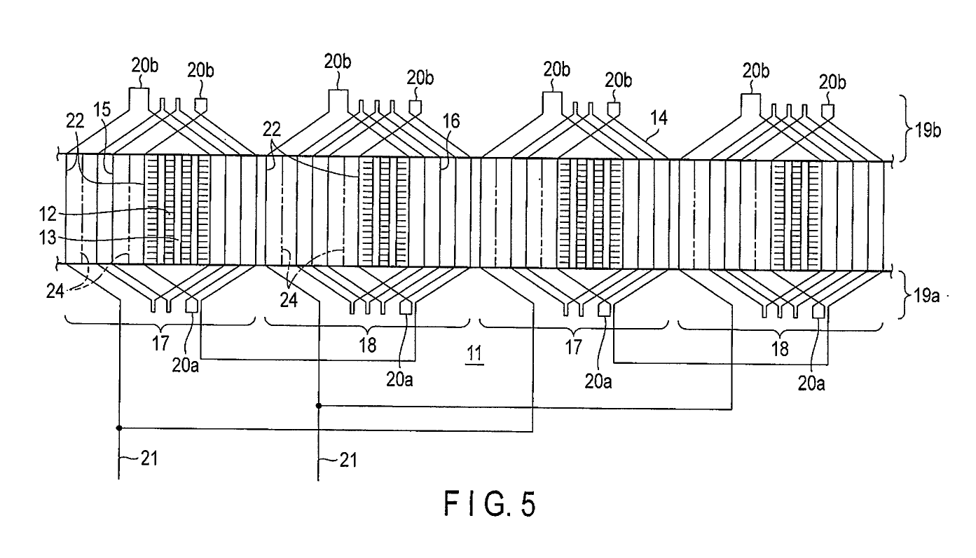

FIG. 5 is a developed schematic diagram showing one phase of an armature winding of a rotating electrical machine according to a fourth embodiment.

In FIG. 5, four jumper wires 20a are provided per phase at a connection side coil end 19a of each of the phase belts 17 and 18, and eight jumper wires 20b are provided per phase at a counter-connection side coil end 19b. In a 4-coil phase belt 17, an upper coil piece 22 in an innermost position and an upper coil piece 22 in an outermost position from the center of the phase are replaced with upper coil pieces 24 of a 5-coil phase belt of an adjacent different phase, respectively. In a 5-coil phase belt 18, an upper coil piece 22 in an innermost position and an upper coil piece 22 in an outermost position from the center of the phase belt are replaced with upper coil pieces 24 of a 4-coil phase belt of an adjacent different phase, respectively.

Table 5 shows the relationship between a coil pitch and a winding coefficient of each order space in the fourth embodiment. Comparing Table 5 with Table 1, fifth-order and seventh-order space winding coefficients are reduced to less than 10% when a coil pitch is 13 or 14 in the fourth embodiment, and a second-order space winding coefficient is lower than a value in a conventional example shown in Table 1. Therefore, a second-order space harmonic component of a magnetic flux formed by an armature current can be reduced.

TABLE 5
Relationship between coil pitch and winding coefficient
in fourth embodiment

| | Coil pitch | | | | | |
|---|---|---|---|---|---|---|
| | 9 | 10 | 11 | 12 | 13 | 14 |
| Basic wave | 0.8053 | 0.8537 | 0.8907 | 0.8902 | 0.9281 | 0.9281 |
| winding | | | | | | |
| coefficient | | | | | | |
| Second-order | 0.0434 | 0.0366 | 0.0279 | 0.0180 | 0.0083 | 0.0083 |
| space winding | | | | | | |
| coefficient | | | | | | |
| Fifth-order | 0.0885 | 0.1101 | 0.1165 | 0.1023 | 0.0808 | 0.0808 |
| space winding | | | | | | |
| coefficient | | | | | | |
| Seventh-order | 0.0745 | 0.0433 | 0.1327 | 0.1395 | 0.0593 | 0.0593 |
| space winding | | | | | | |
| coefficient | | | | | | |

As described above, in the fourth embodiment, in a 4-coil phase belt 17, an upper coil piece 22 in an innermost position and an upper coil piece 22 in an outermost position from the center of the phase belt are replaced with upper coil pieces 24 of a 5-coil phase belt of an adjacent different phase, respectively. In a 5-coil phase belt 18, an upper coil piece 22 in an innermost position and an upper coil piece 22 in an outermost position from the center of a phase are replaced with upper coil pieces 24 of a 4-coil phase belt of an adjacent different phase, respectively. A winding coefficient for a second-order space harmonic can be minimized by setting a coil pitch to 13. A second-order space harmonic component of a magnetic flux generated by an armature current is reduced. A magnetic flux of a second-order space harmonic component acts on a main magnetic flux, and generates a 2-diameter node magnetic excitation force. By reducing a magnetic flux of a second-order space harmonic component, an electromagnetic excitation force of a 2-diameter node is generated, vibration of a 2-diameter node stator core is reduced, and a reliable armature can be provided.

The embodiment is not limited to the configuration shown in the diagrams. The same function and effect can be obtained even when upper coil pieces 15 in FIG. 5 are assumed to be lower coil pieces 16, an upper coil piece 22 replaced with a different phase is assumed to be a lower coil piece 23 replaced with a different phase, an upper coil piece 24 of a different phase is assumed to be a lower coil piece 25 of a different phase, and lower coil pieces 16 are assumed to be upper coil pieces 15. The function and effect are the same even when a lead-out position is changed from the diagrams. Further, in FIG. 5, two parallel windings are formed by connecting two sets of circuit including 4-coil and 5-coil phase belts 17 and 18 in parallel. The same function and effect can be obtained even when an armature winding is formed by connecting two sets of circuit in series.

### Fifth Embodiment

Next, an armature winding of a rotating electrical machine according to a fourth embodiment will be explained.

In the fifth embodiment, elements common to the first embodiment are given the same reference numbers, and an explanation thereof is omitted. Parts different from the first embodiment are mainly explained.

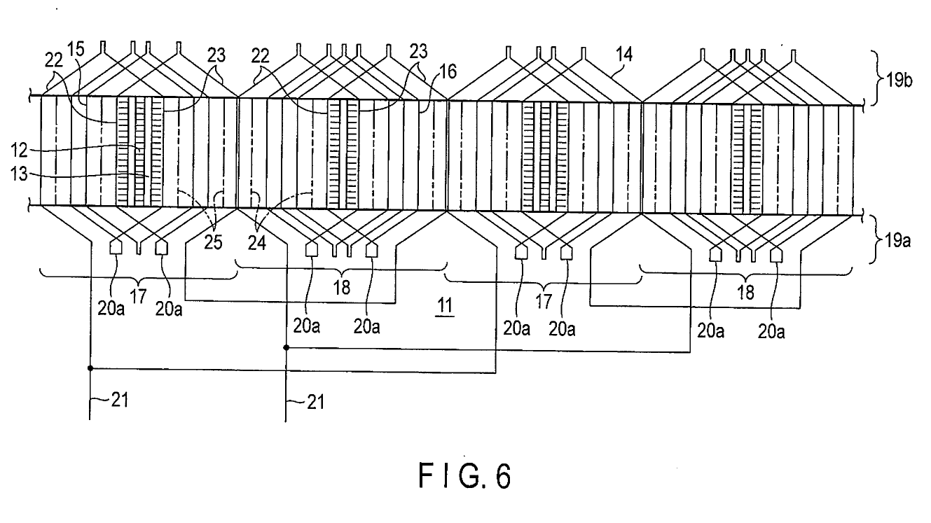

FIG. 6 is a developed schematic diagram showing one phase of an armature winding of a rotating electrical machine according to the fourth embodiment.

In FIG. 6, eight jumper wires 20a are provided per phase at a connection side coil end 19a of each of the phase belts 17 and 18. In a 4-coil phase belt 17, an upper coil piece 22 in an innermost position and a lower coil piece 23 in an outermost position from the center of the phase are replaced with an upper coil piece 24 and a lower coil piece 25 of a 5-coil phase belt of an adjacent different phase, respectively. In a 5-coil phase belt 18, an upper coil piece 22 in an innermost position and a lower coil piece 23 in an outermost position from the center of the phase belt are replaced with an upper piece 24 and a lower coil piece 25 of a 4-coil phase belt of an adjacent different phase, respectively.

Table 6 shows the relationship between a coil pitch and a winding coefficient of each order space in the fifth embodiment. Comparing Table 6 with Table 1, fifth-order and seventh-order space winding coefficients are reduced to less than 10% when a coil pitch is 13 or 14 in the third embodiment, and a second-order space winding coefficient is lower than a value in a conventional example shown in Table 1. Therefore, a second-order space harmonic component of a magnetic flux formed by an armature current can be reduced.

TABLE 6
Relationship between coil pitch and winding coefficient
in fifth embodiment

| | Coil pitch | | | | | |
|---|---|---|---|---|---|---|
| | 9 | 10 | 11 | 12 | 13 | 14 |
| Basic wave | 0.7829 | 0.8300 | 0.8660 | 0.8902 | 0.9024 | 0.9024 |
| winding | | | | | | |
| coefficient | | | | | | |
| Second-order | 0.0381 | 0.0320 | 0.0242 | 0.0151 | 0.0051 | 0.0051 |
| space winding | | | | | | |
| coefficient | | | | | | |
| Fifth-order | 0.0349 | 0.0181 | 0.0047 | 0.0259 | 0.0386 | 0.0386 |
| space winding | | | | | | |
| coefficient | | | | | | |
| Seventh-order | 0.1356 | 0.1500 | 0.0703 | 0.0536 | 0.1438 | 0.1438 |
| space winding | | | | | | |
| coefficient | | | | | | |

As described above, in the fifth embodiment, in a 4-coil phase belt 17, a coil piece 22 in an innermost position and a coil piece 23 in an outermost position from the center of the phase belt are replaced with an upper coil piece 24 and a lower coil piece 25 of a 5-coil phase belt of an adjacent different phase, respectively. In a 5-coil phase belt 18, an upper coil piece 22 in an innermost position and a lower coil piece 23 in an outermost position from the center of the phase belt are replaced with an upper coil piece 24 and a lower coil piece 25 of a 4-coil phase belt of an adjacent different phase, respectively. A winding coefficient for a second-order space harmonic can be reduced. When a coil pitch is set to 13, a winding coefficient of a seventh-order space harmonic is increased, but a winding coefficient of a second-order space harmonic can be minimized. Therefore, a second-order space harmonic component of a magnetic flux generated by an armature current is reduced. A magnetic flux of a second-order space harmonic component acts on a main magnetic flux, and generates a 2-diameter node magnetic excitation force. By reducing a magnetic flux of a second-order space harmonic component, an electromagnetic excitation force of a 2-diameter node is generated, vibration of a 2-diameter node stator core is reduced, and a reliable armature can be provided.

In the fifth embodiment, compared with the first, second and fourth embodiments, a jumper wire 20b at the counter-connection side coil end is unnecessary.

The embodiment is not limited to the configuration shown in the diagrams. The function and effect are the same even when a lead-out position is changed from that shown in the diagrams. Further, in FIG. 6, two parallel windings are formed by connecting two sets of circuit including 4-coil and 5-coil phase belts 17 and 18 in parallel. The same function and effect can be obtained even when an armature winding is formed by connecting two sets of circuit in series.

As explained in detail hereinbefore, according to each embodiment, there can be provided an armature winding of a rotating electrical machine, in which an electromagnetic excitation force of 4-pole components caused by a magnetic flux generated by an armature current is decreased, vibration of an armature core is decreased, and the reliability is increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A 3-phase 4-pole 2-layer armature winding of a rotating electrical machine, a winding of each phase of the armature winding forming a series coil, each series coil comprising:
upper coil pieces and lower coil pieces which are connected each other at a connection side coil end and a counter-connection side coil end, the upper coil pieces and lower coil pieces being placed in 54 slots provided in an armature core,
at least one coil piece of the upper and lower coil pieces, provided in at least one of an innermost position and an outermost position from the center of a phase belt of each phase, being replaced with a coil piece of an adjacent phase.

2. The armature winding of the rotating electrical machine according to claim 1, wherein in the upper coil pieces or the lower coil pieces of each phase, a coil piece in an outermost position from the center of a phase belt of each phase is replaced with a coil piece of an adjacent phase, in a 5-coil phase belt, and a coil piece in an innermost position from the center of a phase belt of each phase is replaced with a coil piece of an adjacent phase, in a 4-coil phase belt.

3. The armature winding of the rotating electrical machine according to claim 2, wherein a coil pitch is set to one of 10 to 12.

4. The armature winding of the rotating electrical machine according to claim 1, wherein
outermost upper and lower coil pieces in outermost positions from the center of a phase belt of each phase are replaced with coil pieces of an adjacent phase, in a 5-coil phase belt, and
innermost upper and lower coil pieces in innermost positions from the center of a phase belt of each phase are replaced with coil pieces of an adjacent phase, in a 4-coil phase belt.

5. The armature winding of the rotating electrical machine according to claim 4, wherein a coil pitch is set to one of 9 to 11.

6. The armature winding of the rotating electrical machine according to claim 1, wherein
an upper coil piece in an outermost position and a lower coil piece in an innermost position, or a lower coil piece in an outermost position and an upper coil piece in an innermost position, from the center of a phase belt of each phase are replaced with coil pieces of an adjacent phase, in a 5-coil phase belt, and
an upper coil piece in an innermost position and a lower coil piece in an outermost position, or an upper coil piece in an outermost position and a lower coil piece in an innermost position, from the center of a phase belt of each phase are replaced with coil pieces of an adjacent phase, in a 4-coil phase belt.

7. The armature winding of the rotating electrical machine according to claim 6, wherein a coil pitch is set to one of 12 to 14.

8. The armature winding of the rotating electrical machine according to claim 1, wherein in the upper coil pieces or the lower coil pieces in a phase belt of each phase, a coil piece in an outermost position and a coil piece in an innermost position from the center of a phase belt of each phase are replaced with coil pieces of an adjacent phase.

9. The armature winding of the rotating electrical machine according to claim 8, wherein a coil pitch is set to one of 13 and 14.

10. The armature winding of the rotating electrical machine according to claim 1, wherein innermost upper and lower coil pieces in innermost positions and outermost upper and lower coil pieces in outermost positions from the center of a phase belt are replaced with coil pieces of an adjacent phase.

11. The armature winding of the rotating electrical machine according to claim 10, wherein a coil pitch is set to one of 13 and 14.
